(19) United States
(12) Patent Application Publication
(10) Pub. No.: US 2009/0240373 A1
(43) Pub. Date: Sep. 24, 2009

(54) ESTABLISHING A USE CYCLE USING A CONTAINER CONDITION

(76) Inventor: Rork S. Brown, Enfield, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/053,608

(22) Filed: Mar. 23, 2008

(51) Int. Cl. G05B 15/00

(52) U.S. Cl. 700/275

(57) ABSTRACT

An example method of establishing a use cycle using container conditions includes monitoring a container condition and adjusting a use cycle of the container or a component held by the container using the container condition.

### BACKGROUND

This invention relates generally to using container conditions when establishing use cycles for containers, and components held by containers.

Containers are known and used for holding various components. Containers hold components during shipping, during storage, etc. Containers protect the components from exposure to environmental elements prior to installing the components within a desired assembly, for example. Environmental conditions often affect components, such as aerospace components. Exposing the aerospace components to some environmental conditions, may undesirably reduce the operating life of the aerospace components within a gas turbine engine assembly, for example.

Once removed from the container and used within an assembly for example, components are often assigned a use cycle to facilitate early detection of issues potentially affecting component performance. Typically, when the use cycle expires, the component is reworked, inspected, etc. Use cycles are often based solely on the component's time in service. Accurately projecting the use cycle is important, at least because reworking and inspecting components is expensive. Many containers also have a use cycle based upon the container's time in service. Inaccurately projecting the use cycle for a component or a container may result in unnecessary or untimely rework and inspection.

### SUMMARY

An example method of establishing a use cycle using container conditions includes monitoring a container condition and adjusting a use cycle of the container or a component held by the container using the container condition.

An example component container assembly includes a container for holding a component and a sensor for monitoring a container condition of the container. The container or the component has a projected use cycle that is adjustable based on the container condition.

An example gas turbine engine component container assembly includes a container for holding a gas turbine engine component and a sensor for monitoring at least one container condition of the container or the gas turbine engine component.

These and other features of the example disclosure can be best understood from the following specification and drawings, the following of which is a brief description:

### BRIEF DESCRIPTION OF THE DRAWINGS

FIG. 1 schematically shows an example gas turbine engine.

FIG. 2 shows an example component container assembly.

FIG. 3 shows a system incorporating multiple FIG. 2 component container assemblies.

FIG. 4A shows an example container use cycle.

FIG. 4B shows an example component use cycle.

FIG. 5 shows an example of review method used within the component container assembly system of FIG. 3.

FIG. 6 shows an example predictive method used by the component container assembly system of FIG. 3.

### DETAILED DESCRIPTION OF THE PREFERRED EMBODIMENT

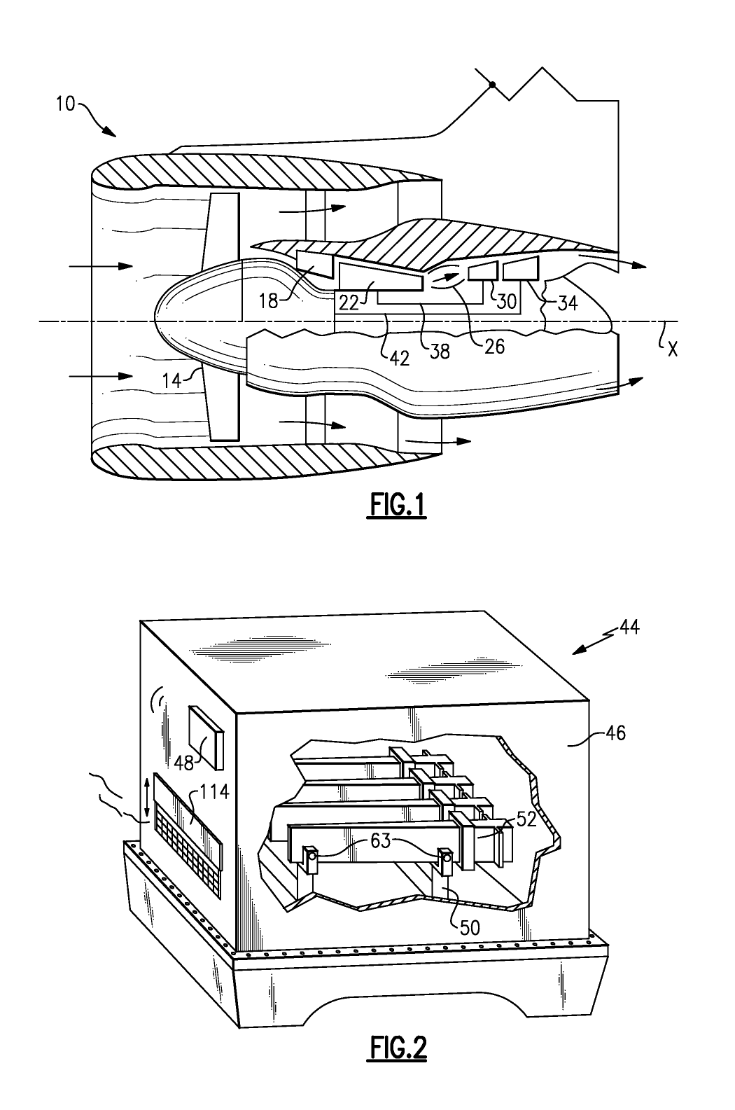

FIG. 1 schematically illustrates an example gas turbine engine 10 including (in serial flow communication) a fan section 14, a low pressure compressor 18, a high pressure compressor 22, a combustor 26, a high pressure turbine 30, and a low pressure turbine 34. The gas turbine engine 10 is circumferentially disposed about an engine centerline X. During operation, the fan section 14 intakes air, the compressors 18, 22 pressurize the air. The combustor 26 burns fuel mixed with the pressurized air. The high and low pressure turbines 30, 34 extract energy from the combustion gases flowing from the combustor 26.

In a two-spool design, the high pressure turbine 30 utilizes the extracted energy from the hot combustion gases to power the high pressure compressor 22 through a high speed shaft 38, and a low pressure turbine 34 utilizes the energy extracted from the hot combustion gases to power the low pressure compressor 18 and the fan section 14 through a low speed shaft 42. The example method is not applied only to components within the two-spool gas turbine architecture described above and may be used with other architectures such as a single spool axial design, a three spool axial design and other architectures. That is, there are various types of gas turbine engine component and components within other systems, many of which could benefit from the examples disclosed herein.

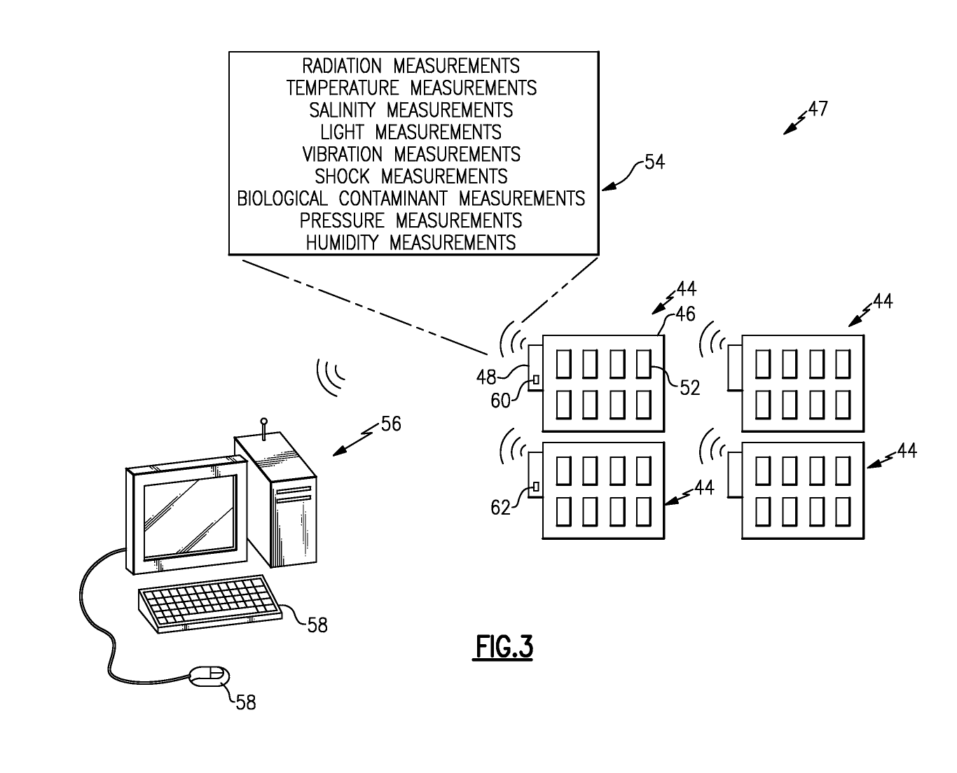

As shown in FIG. 2, an example component container assembly 44 includes a container 46 and a sensor 48. A fixture portion 50 of the container 46 holds at least one component 52. The example component container assembly 44 holds the component 52 during transport. Other examples include storing the component 52 within the component container assembly 44. Environmental or other conditions external to the container 46 can affect the component 52.

Referring now to the schematic view of FIG. 3 with continuing reference to FIG. 2, an example container monitoring system 47 includes at least one example sensor 48 for wirelessly broadcasting at least one of a plurality of container conditions 54 to a general purpose computer 56. The general purpose computer 56 includes various Input/Output devices 58, such as a keyboard, mouse, and display. A user interacts with the general purpose computer 56 to obtain information about the component container assembly 44. As shown, more than one component container assembly 44 wirelessly communicates measurement information to the general purpose computer 56. The example general purpose computer 56 can be used to implement various functionality, such as methods attributable to the monitoring or evaluating the container conditions 54.

In terms of hardware architecture, the general purpose computer 56 can include a processor, memory, and one or more input and/or output (I/O) device interface(s) 58 that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), multicore processor, an auxiliary processor among several processors associated with the computing device, a semiconductor based microprocessor (in the form of a microchip or chip set) or generally any device for executing software instructions.

In one example, the general purpose computer 56 records the container conditions 54 for later recall by a user. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices 58 that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the general purpose computer 56 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The sensor 48 may measure one or more of the container conditions 54 adjacent to or within the container 46. The example container conditions 54 include, but are not limited to, measurements of the radiation, temperature, salinity, light, vibration, shock, biological contaminant, pressure, and humidity adjacent to or within the container 46 when the container 46 is closed. The example container conditions 54 shown are for illustration purposes. Other examples may include additional container conditions 54 not mentioned here.

In this example, the sensor 48 includes a photovoltaic sensor portion 60 for measuring light exposure within the associated container 46. Another sensor 48 includes a microelectromechanical system sensor portion 62 for measuring biological contaminants within the associated component container assembly 44. A person skilled in the art and having the benefit of this disclosure would be able to configure the photovoltaic sensor portion 60 and the microelectromechanical system sensor portion 62 within the respective sensor 48 to read the respective container conditions 54.

In addition to the sensor 48 positioned near a perimeter of the container 46, other portions of the example container assembly 44 monitor container conditions 54. For example, as shown in FIG. 1, the fixture 50 may include a shock sensor 63 for measuring shock to the component 52. Positioning the shock sensor 63 proximate the fixture, instead of near the perimeter of the container 46, facilitates sensing shock to the component 52.

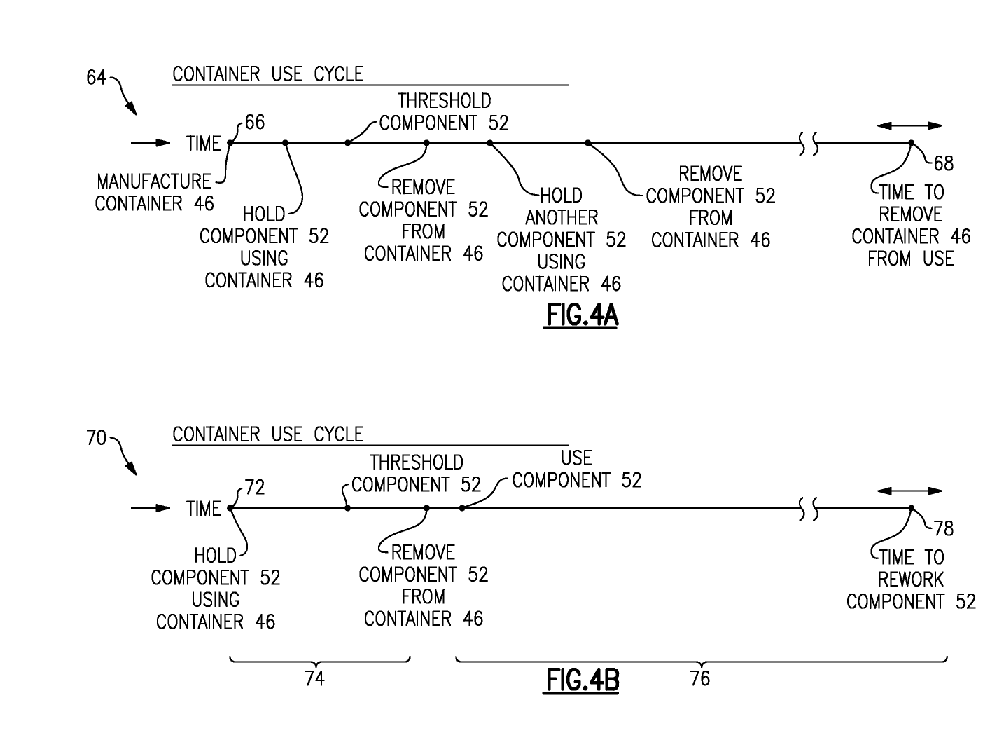

Referring now to FIGS. 4A and 4B with continuing reference to FIG. 3, an example container use cycle 64 begins when the container 46 is manufactured at 66. The example container use cycle 64 has been simplified for sake of illustration. That is, although the container use cycle 64 shows that the container 46 is used two times for holding and transporting component 52, many more uses are possible and probable. The container 46 is removed from use and is recycled, for example, when the container use cycle 64 ends at 68.

Formerly, the container conditions 54 were not used when determining the end at 68 of the container use cycle 64. Instead, the container 46 was removed based on an amount of use or a passage of time. The end at 68 of the example container use cycle 64 can adjust using the container conditions 54.

An example component use cycle 70, which has been simplified for sake of illustration, begins when the component 52 is held by the container 46 at 72. The component use cycle 70 includes a time period 74 when the component 52 is held by the container 46, and a time period 76 when the component 52 is in use. Usage may include operating a fan blade, a type of component 52, within the fan section 14 of the gas turbine engine 10 (FIG. 1). The component use cycle 70 is removed from use for rework, for example, when the component use cycle 70 ends at 78.

Formerly, the container conditions 54 during the time period 74 were not used when determining the end of the component use cycle at 78. The example component use cycle 70 utilizes the container conditions 54 obtained when the component 52 was held by the container 46 during time period 74.

Referring to FIG. 5 with continuing reference to FIG. 4B, an example method 84 for establishing the end at 78 of the component use cycle 70 includes collecting storage information at step 88 and collecting use information at step 92. In this example, the storage information at step 88 includes the container conditions 54 when the component 20 is held by the container 46 during storage and transport. The use information at step 92 is collected after removing the component 20 from the container 46 during the time period 76.

Using information from step 88 and step 92, a user establishes the component use cycle 70 at 96. As an example, the user may collect storage information at step 88 indicating that the component 52 was transported in extreme heat and humidity for several months, which, as known, can weaken the component 52. The method 84 utilizes this information when establishing the example component use cycle at 96. The information would result in a shorter use cycle than another use cycle established without this information. The component 52 that was transported in extreme heat and humidity for several months is thus desirably removed for rework sooner than another component 52 that was transported in more desirable conditions.

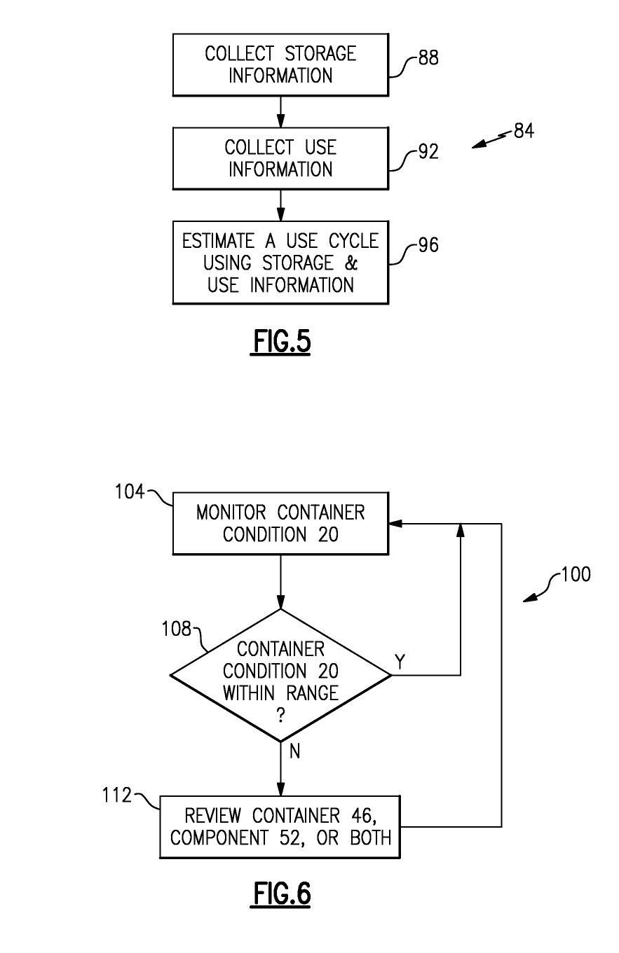

As shown in FIG. 6 with continuing reference to FIG. 4B, in another example, an example method 100 monitors at least one of the container conditions 54 at 104. If the container conditions 54 falls within a range at 108, the monitoring continues at 104. If the container condition falls outside of the range at 108, a user reviews the container 46, the component 52, or both at 112. After review, the method 100 continues to monitor the container conditions 54 at 104.

Utilizing the method 100 alerts the user to the container conditions 54 potentially affecting the component use cycle 70. The method 100 alerts the user prior to removing the component 52 from the container 46 to facilitate maximizing the component use cycle 70. For example, the method 100 may alert the user to high humidity levels within the container 46. As known, extended exposure to high humidity levels can damage the component 52. The method 100 facilitates the user addressing the high humidity problem by, for example, opening a vent 114 (FIG. 2) to circulate air within the container 46 to decrease the humidity levels. The method 100 alerts the user when the humidity levels fall within the range at 108 so the user can then close the vent 114 after the humidity levels return to an acceptable level. In another example, pressure release valves (not shown) secured to the container 46 facilitate changing the humidity level within the container 46. A multicore processor within the general purpose computer 56 controls humidity levels by opening and closing the pressure release valves for example.

Although a preferred embodiment has been disclosed, a worker of ordinary skill in this art would recognize that certain modifications would come within the scope of this invention. For that reason, the following claims should be studied to determine the true scope and content of this invention.

I claim:

1. A method of establishing a use cycle using container conditions, comprising:
(a) monitoring at least one container condition; and
(b) adjusting a use cycle of the at least the container or a component held by the container based on the at least one container condition.

2. The method of claim 1, including recording the at least one container condition.

3. The method of claim 1, including alerting a user when the at least one container condition is not within a range of container conditions.

4. The method of claim 1, including wirelessly transporting the at least one container condition monitored in said step (a).

5. The method of claim 1, wherein the component comprises a reworked component.

6. The method of claim 1, wherein the component comprises a gas turbine engine component.

7. The method of claim 1, wherein the monitoring step comprises measuring humidity within the container.

8. The method of claim 7, including opening and closing portion of the container based on the measured humidity.

9. The method of claim 1, including transporting the container.

10. The method of claim 1, including storing the container.

11. A component container assembly, comprising:
a container for holding a component; and
a sensor for monitoring at least one container condition of said container, wherein at least one of said container and said component has a use cycle that is adjustable based on the at least one container condition.

12. The component container of claim 11, wherein said sensor monitors conditions adjacent said container.

13. The component container of claim 11, wherein said sensor monitors conditions within said container.

14. The component container of claim 11, wherein said sensor comprises a photovoltaic sensor.

15. The component container of claim 11, wherein said sensor comprises a microelectromechanical systems sensor.

16. A gas turbine engine component container assembly, comprising:
a container for holding a gas turbine engine component; and
a sensor for monitoring at least one container condition of said container or the gas turbine engine component.

17. The container assembly of claim 16, wherein said sensor comprises a gage for measuring stress on said gas turbine engine component.
